(19) United States
(12) Patent Application Publication
(10) Pub. No.: US 2026/0198461 A1
(43) Pub. Date: Jul. 16, 2026

(54) AUTOMATED ASSESSMENT AND SORTING SYSTEM FOR AN UNCONSTRAINED STREAM OF BABY CHICKS USING POSE-INVARIANT PARALLEL AI ANALYSIS AND MULTI-FRAME ENSEMBLE IMAGING

(71) Applicants: Thalia Estens Musa, Lithia, FL (US); Maximilian Cody Evans, Lithia, FL (US); Enrique Estens Ramos, Lerma (MX)

(72) Inventors: Thalia Estens Musa, Lithia, FL (US); Maximilian Cody Evans, Lithia, FL (US); Enrique Estens Ramos, Lerma (MX)

(21) Appl. No.: 19/444,181

(22) Filed: Jan. 8, 2026

Related U.S. Application Data
(60) Provisional application No. 63/743,951, filed on Jan. 10, 2025.

(51) Int. Cl. A01K 45/00; G06V 10/141; G06V 10/764

(52) U.S. Cl. CPC A01K 45/00; G06V 10/141; G06V 10/764

(57) ABSTRACT

An Automated Assessment and Sorting System for Baby Chicks (AGSS) utilizing a stationary inclined platform and a multi-shot optical imaging system for real-time, parallel classification of unconstrained chicks. The system captures image series of chicks in random orientations. A pose-invariant deep learning algorithm—implemented as a unified or modular architecture—aggregates classification results to determine gender, physical parameters, and health status. Based on this determination, a computer-controlled air stream system separates chicks into categories such as Male, Female, Grade A/B, or Cull. Uncertain chicks are optionally diverted for manual inspection, secondary automated sorting, or re-introduction via a return mechanism. By eliminating complex mechanical singulation and positioning devices, the system significantly increases throughput, reduces machine footprint, and improves operational efficiency while enabling multi-criteria assessment of a continuous stream of chicks.

### CROSS-REFERENCE TO RELATED APPLICATIONS

This application claims the benefit of priority to U.S. Provisional Ser. No. 63/743,951, filed on Jan. 10, 2025, the contents of which are incorporated herein by reference in their entirety.

### TECHNICAL FIELD

This invention relates to an automated system and method for analyzing and sorting baby chicks. Specifically, the invention utilizes high-speed, pose-invariant deep learning algorithms and multi-frame optical imaging to concurrently analyze multiple unconstrained chicks moving across a stationary platform, thereby achieving high-throughput sorting based on gender, size, health, and/or physiological vitality (grading and culling) without the size, complexity, or maintenance burden of mechanical positioning required by prior art.

### BACKGROUND OF THE INVENTION

Traditional methods of determining the gender and quality of baby chicks are labor-intensive, require extensive training, and are prone to human error. The prior art contains numerous attempts to automate this process, but they are often limited to single-function operations (only sexing) and suffer from mechanical limitations, primarily the need to process chicks individually.

Existing automated solutions typically rely on complex mechanical manipulation, invasive techniques, or expensive sensing modalities that restrict throughput and increase machine size. For example, U.S. Pat. No. 3,994,292 (Goodwin) describes an early chick processing system using conveyors, but it relies on manual counting or simple mechanical handling, lacking the ability to process an unconstrained stream for automated gender determination.

Other systems, such as U.S. Pat. No. 4,417,663 (Suzuki), describe an automated system requiring invasive exposure of the vent. This necessitates precise, stressful physical handling of chicks one by one to expose the vent. The present invention is strictly non-invasive and handles a continuous stream. Similarly, EP 1,092,347 A1 (Yavnai/Efrochan) describes methods of inducing chicks to lose equilibrium—using means such as electric or acoustic shock—to force them to spread their wings. These rely on distressing the animal to ensure a specific pose is held for singular processing. The present invention processes chicks in their natural, unconstrained motion within a crowded stream without induced stress.

Further attempts, such as U.S. Patent Publication 2001/0030146 A1 (Almon), describe a system that utilizes acoustic emissions (vocalizations) to identify gender. While automated, such systems are sensitive to environmental noise and the specific behavioral state of the bird. Regarding vision systems, U.S. Pat. No. 6,396,938 (Tao/University of Arkansas) focuses on automatic feather sexing using UV imaging, which typically requires a constrained view where chicks are processed individually to ensure wing features are mechanically presented to the camera without occlusion.

Alternative sensing methods also present limitations. U.S. Pat. No. 6,512,839 (Toelken) describes a method using ultrasound to determine gender. This requires targeting the vent/cloaca with ultrasonic energy, necessitating precise singulation and orientation of each chick individually. U.S. Pat. No. 7,950,347 (Gidlöf/ECAT) details a system for automated feather sexing but relies on specific mechanical conveyance to position each bird individually to present the wing to the camera. U.S. Pat. No. 10,806,124 (Karimpour/Targan Inc.), currently under active dispute (e.g., IPR2024-00595), describes assessment methods that typically imply a serialized flow or individual assessment to ensure accurate readings, rather than the unconstrained parallel stream analysis of the present invention. U.S. Pat. No. 6,029,080 (Reynnells) focuses on in-ovo sex determination, which involves processing eggs in fixed positions, not a flowing stream of hatched chicks.

Regarding general industrial sorting, systems like those from Satake Corporation and Tomra Sorting are optimized for rigid, inanimate objects. While they handle bulk, they typically require objects to be singulated in chutes or spread into a monolayer to avoid overlap. They lack the pose-invariant biological analysis required to grade a living chick—which changes shape and overlaps with others—in a continuous, unconstrained stream.

There remains a critical gap for an automated, high-throughput solution that achieves reliable classification based on gender, size, and health using non-invasive characteristics without mechanically constraining or separating the chicks one by one, allowing for flexible sorting, grading, and culling in a single compact apparatus.

### SUMMARY OF THE INVENTION

The Automated Assessment and Sorting System for Baby Chicks offers an innovative solution by replacing mechanical constraints with advanced, pose-invariant Artificial Intelligence and multi-perspective data collection. The system's novelty lies in its ability to simultaneously process multiple chicks moving in random, unconstrained orientations for sexing, grading, and culling applications.

Chicks are placed onto a stationary inclined platform made from materials including, but not limited to, specialized glass, transparent plastic/polymer, metal, opaque plastic, or any other suitable material, shaped in flat, convex, concave, or L-shaped designs to ensure a controlled sliding movement. The platform's material properties are selected based on whether under-side imaging is required (e.g., for navel health grading). Crucially, this platform allows the chicks to move in a parallel flow without forcing a specific orientation.

A high-speed multi-shot optical imaging system captures a continuous series of images. The primary imaging perspective captures the flow of chicks from any angle or position. To further resolve occlusions, auxiliary cameras can be positioned at various angles. The system uses intense, constant illumination to achieve a motion-free image clarity. The set of images collected for each chick is processed in real-time by a deep learning processor. This processor utilizes advanced neural network architectures configured as a flexible architecture ranging from a single, unified end-to-end model to a multi-stage modular system, or any combination of integrated and distinct models. The system analyzes features related to gender (feather/color), size (pixel area/volume), and vitality (motion analysis across frames) to categorize chicks into Male/Female, Grade A/B (Size/Strength), or Cull (Unhealthy/Deformed).

Once classified, the precise location of each chick is tracked, and a computer-controlled air stream system is triggered. The air streams are precisely directed to gently nudge the chicks towards category-specific collection bins or optionally into a re-sorting mechanism.

### BRIEF DESCRIPTION OF THE DRAWINGS

FIG. 1 shows the hardware configuration of the system, including: the conveyor belt moving chicks (100); the stationary inclined platform on which they slide (110); an exemplary setting of the optical imaging camera (120); air actuators (130); separators (140); a mechanism to return uncertain chicks (150); and a conveyor for chick moving or for chick box moving (160).

FIG. 2 is a sample of possible shapes for the inclined platform, which may include straight, L-shaped, concave, or convex configurations.

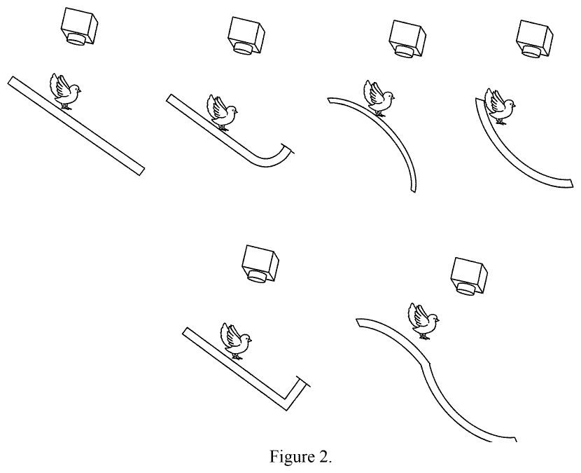

FIG. 3 is a flowchart demonstrating the logic of the deep learning processor, illustrating a flexible architecture that may include implicit or explicit segmentation, feature extraction, and probabilistic classification steps.

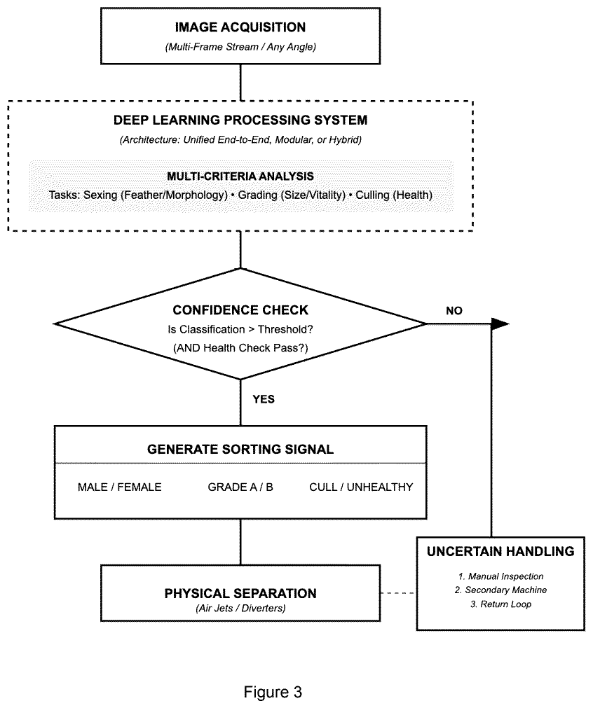

FIG. 4 is a schematic representation of the multi-frame image acquisition process showing the capture of a chick in random orientations across an ensemble of frames.

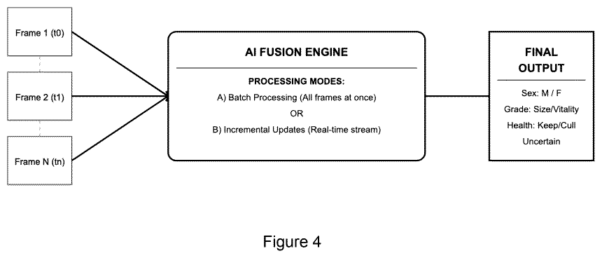

### DETAILED DESCRIPTION OF THE INVENTION

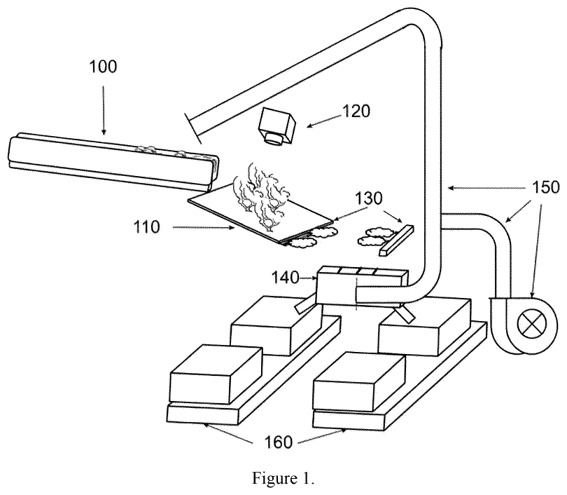

1. Inspection Platform (FIG. 1. 110): Baby chicks are deposited into a flow onto a stationary inclined platform. The platform may be constructed from transparent materials to enable optional under-side imaging (crucial for detecting omphalitis or navel health for culling), or from opaque materials. The platform's design facilitates smooth, unconstrained movement without external mechanical orientation.
2. High-Speed Multi-Shot Optical Imaging System (FIG. 1. 120): The primary imaging system captures a rapid series of individual image frames from a primary perspective. Optional auxiliary cameras may be positioned at various angles. The system uses intense, constant, high-power illumination to freeze motion. The multi-frame capture allows for temporal analysis of chick movement, which is used as a proxy for chick strength and vitality during the grading process. Furthermore, the aggregation of multiple sources of information from these frames enables enhanced precision in the system's sexing, grading, and culling decisions.
3. Image Processing and Parallel AI Classification: Captured image sets are routed to a powerful deep learning system. The deep learning system is architecturally flexible and may be implemented as a single, unified neural network, a collection of distinct modular networks (e.g., separate models for segmentation, feature extraction, and classification), or any hybrid combination of one or more models working in concert. This system utilizes advanced deep learning algorithms to perform real-time, multi-criteria analysis.

Dynamic Object Segmentation & Tracking: Delineating boundaries of each chick across the series of frames.

### Feature Extraction (Multi-Purpose)

For Sexing: Identifying wing feather patterns, feather color, and external morphology.
For Grading: Calculating physical dimensions (size/volume) and analyzing temporal motion patterns (activity levels) to assign a vitality score (e.g., Grade A vs. Grade B).
For Culling: Detecting visual anomalies such as deformities, unhealed navels (via bottom

camera), or signs of lethargy.

Probabilistic Concurrent Classification: Applying a probabilistic or ensemble fusion algorithm to integrate the results. The processing logic allows for image data to be analyzed either as a complete batch (all frames analyzed simultaneously) or sequentially (frame-by-frame analysis with incremental prediction updates using new information as it appears). This integration yields the most probable classification into user-defined categories: Gender (Male/Female), Grade (Size/Vitality), and/or Health (Keep/Cull).
4. Air Stream Separation (FIG. 1. 130, 140): The output generates simultaneous, distinct sorting signals for each chick. A computer-controlled air stream apparatus (FIG. 1. 130) generates precisely directed airflows to separate chicks into multiple outputs (e.g., Bin 1: Grade A Females, Bin 2: Grade A Males, Bin 3: Grade B/Culls).
5. Handling Uncertain/Unhealthy Chicks (FIG. 1. 150) (Configurable Diversion): If the algorithm cannot determine the classification with sufficient confidence, or if the chick is identified as unhealthy (Cull), the system is configured to route these chicks to one of several destinations based on operational requirements:
   Manual Classification: Diverting to a collection area for human inspection.
   Secondary Machine: Transferring to a downstream automated unit for further analysis.
   Re-introduction (Return Loop): Using the optional return mechanism (FIG. 1. 150) to re-introduce the chick to the same machine for re-evaluation.
   Cull Removal: Permanently removing unhealthy chicks to a separate stream.
6. Continuous Cycle (Optional): When the reintroduction option is utilized, chicks are seamlessly reintroduced for another round of analysis, maximizing classification rates for difficult-to-sort subjects.

What is claimed is:

1. A computer-implemented method for high-throughput, automated assessment and sorting of baby chicks, comprising the steps of:
(a) Providing a stationary inclined platform or any other mechanism configured to support an unconstrained parallel flow of a plurality of chicks, wherein said platform or mechanism is transparent, opaque, or comprises transparent sections;
(b) Capturing a multi-frame series of digital images from an optical imaging system positioned at a primary angle or position relative to the platform, said series capturing two or more chicks concurrently in random, unconstrained orientations, and optionally capturing images from auxiliary angles;
(c) Executing a pose-invariant deep learning algorithm on said multi-frame series, wherein said algorithm is configured to differentiate individual chicks and analyze visual features within the said multi-frame series, said differentiation and analysis being performed either explicitly via distinct segmentation and extraction modules or implicitly within a single unified model;
(d) Using said pose-invariant deep learning algorithm to identify visual cues associated with gender (feather/morphology), physical size, physiological vitality (based on temporal movement patterns), and health status;
(e) Generating a final classification for each chick by integrating the analysis of the said multi-frame series, using a processing architecture selected from the group consisting of: a single unified deep learning model, a modular system of cooperating models, or any hybrid combination thereof, wherein said integration processes images either as a batch or by incrementally updating predictions, yielding a classification into one of a plurality of user-defined categories selected from the group consisting of: Male, Female, Graded Size/Strength, and Cull/Unhealthy; and
(f) Issuing a plurality of simultaneous, distinct sorting signals corresponding to the determined categories.

2. The method of claim 1, wherein the said multi-frame series acquisition is enabled by intense, constant illumination positioned to minimize camera exposure time and reduce motion blur from chicks in motion.

3. An apparatus for parallel assessment and sorting of baby chicks, comprising:
(a) A stationary inspection platform or mechanism configured to support an unconstrained parallel flow of chicks, wherein said platform or mechanism may be transparent, opaque, or partially transparent;
(b) A multi-shot optical imaging system configured to capture a series of image frames comprising two or more chicks simultaneously, wherein said system comprises at least one primary camera positioned at any angle or position relative to the platform, and optionally comprises auxiliary cameras positioned at oblique, lateral, or bottom angles;
(c) A computer processor in communication with the imaging system and configured to execute a pose-invariant deep learning system implemented as either a single, unified neural network, a modular system of cooperating deep learning models, or a hybrid combination thereof, said system configured for concurrent classification of chicks into gender-based, grade-based (size/vitality), or health-based (cull) categories based on non-invasive visual and temporal cues; and
(d) A computer-controlled air stream apparatus configured to receive a plurality of simultaneous classification signals and capable of independently and concurrently separating each of the two or more chicks into distinct output destinations based on their classification, including diverting chicks classified into an uncertain category to a manual inspection station, a secondary automated machine, or a return mechanism.

4. The apparatus of claim 3, wherein the optical imaging system further comprises a system for intense, constant illumination positioned to minimize camera exposure time and motion blur of chicks moving across the platform.

5. The apparatus of claim 3, wherein the system is configurable to divert said chicks classified into said uncertain category to a manual inspection station, a secondary automated sorting machine, or back to the inspection platform via a return mechanism for re-evaluation.

6. A method for increasing throughput of automated chick processing, comprising the steps of eliminating mechanical positioning devices commonly used in chick sexing systems; and
replacing said mechanical positioning devices with a multi-shot, pose-invariant parallel deep learning algorithm configured to sex, grade, and/or cull multiple chicks simultaneously based on non-invasive visual features extracted from a multi-frame image set capturing the chicks in random orientation.
